(19) United States
(12) Patent Application Publication
(10) Pub. No.: US 2014/0278970 A1
(43) Pub. Date: Sep. 18, 2014

(54) USING A FEDERATED NETWORK OF RETAILERS TO PROVIDE MESSAGES TO NETWORK CUSTOMERS OF ALL LOCATIONS OF A PARTICULAR NETWORK MERCHANT

(71) Applicant: BANK OF AMERICA CORPORATION, Charlotte, NC (US)

(72) Inventors: Matthew A. Calman, Charlotte, NC (US); Laura Corinne Bondesen, Charlotte, NC (US); David M. Grigg, Rock Hill, SC (US)

(73) Assignee: BANK OF AMERICA CORPORATION, Charlotte, NC (US)

(21) Appl. No.: 13/830,010

(22) Filed: Mar. 14, 2013

(51) Int. Cl. G06Q 30/02

(52) U.S. Cl. CPC G06Q 30/0259
USPC 705/14.53; 705/14.57

(57) ABSTRACT

Embodiments of the invention are directed to systems, methods and computer program products for communicating messages to one or more customers associated with a federated network of retailers. Embodiments determine that one or more customers associated with the federated network of retailers are in proximity to a retailer physical location associated with a retailer that is a member of the network; and present an offer to one or more of the federated network customers in proximity to the retailer. In some embodiments, determining comprises recognizing a mobile device is associated with a customer of at least one retailer that is a member of the federated network of retailers. Some embodiments determine that a customer in proximity to the location is not a customer of the retailer associated with the location and is a customer associated with the network of retailers; and present the offer is based on the determination.

### BACKGROUND

A retailer or merchant may wish to provide messages and/or offers to customers outside the retailer's network of current customers.

### BRIEF SUMMARY

Embodiments of the invention are directed to systems, methods and computer program products for providing interaction efficiency information to a customer.

According to embodiments of the invention, a system includes a memory device storing computer executable code and a processing device to execute the computer executable code to cause the processing device to determine that one or more customers associated with the federated network of retailers are in proximity to a retailer physical location associated with a retailer that is a member of the federated network of retailers; and present an offer to one or more of the federated network customers in proximity to the retailer.

In some embodiments determining comprises recognizing a mobile device is associated with a customer of at least one retailer that is a member of the federated network of retailers. In some embodiments, the computer executable code is further to cause the processing device to determine that a customer in proximity to the retailer physical location is not a customer of the retailer associated with the physical location and is a customer associated with the federated network of retailers; and present the offer is based on determination. In some embodiments, the offer is associated with the physical location or the retailer associated with the physical location.

In some embodiments, the computer executable code is further to cause the processing device to collect transaction data and mobile device data, each associated with customers of a plurality of retailers that are members of the federated network of retailers; and correlate and storing the transaction data and the mobile device data. In some such embodiments, the computer executable code is further to cause the processing device to access the stored transaction data; and, using the accessed transaction data, determine to which of the network customers to present offers. In other such embodiments, the computer executable code is further to cause the processing device to access the stored mobile device data; and, using the accessed mobile device data, determine which of the network customers are proximate the retailer physical location.

According to embodiments of the invention, a computer program product is configured for communicating messages to one or more customers associated with a federated network of retailers, the computer program product comprising a non-transitory computer readable medium having computer executable code stored thereon to cause a processing device to determine that one or more customers associated with the federated network of retailers are in proximity to a retailer physical location associated with a retailer that is a member of the federated network of retailers; and present an offer to one or more of the federated network customers in proximity to the retailer.

In some embodiments, determining comprises recognizing a mobile device is associated with a customer of at least one retailer that is a member of the federated network of retailers. In some embodiments, the computer executable code is further to cause the processing device to determine that a customer in proximity to the retailer physical location is not a customer of the retailer associated with the physical location and is a customer associated with the federated network of retailers; and present the offer is based on determination. In some embodiments, the offer is associated with the physical location or the retailer associated with the physical location.

In some embodiments, the computer executable code is further to cause the processing device to collect transaction data and mobile device data, each associated with customers of a plurality of retailers that are members of the federated network of retailers; and correlate and storing the transaction data and the mobile device data. In some such embodiments, the computer executable code is further to cause the processing device to access the stored transaction data; and, using the accessed transaction data, determine to which of the network customers to present offers. In other such embodiments, the computer executable code is further to cause the processing device to access the stored mobile device data; and, using the accessed mobile device data, determine which of the network customers are proximate the retailer physical location.

According to embodiments of the invention, a computer-implemented method for communicating messages to one or more customers associated with a federated network of retailers includes providing a memory device storing computer executable code and a processing device to execute the computer executable code to cause the processing device to determine that one or more customers associated with the federated network of retailers are in proximity to a retailer physical location associated with a retailer that is a member of the federated network of retailers; and present an offer to one or more of the federated network customers in proximity to the retailer.

In some embodiments, determining comprises recognizing a mobile device is associated with a customer of at least one retailer that is a member of the federated network of retailers. In some embodiments, the computer executable code is further to cause the processing device to determine that a customer in proximity to the retailer physical location is not a customer of the retailer associated with the physical location and is a customer associated with the federated network of retailers; and present the offer is based on determination. In some embodiments, the offer is associated with the physical location or the retailer associated with the physical location.

In some embodiments, the computer executable code is further to cause the processing device to collect transaction data and mobile device data, each associated with customers of a plurality of retailers that are members of the federated network of retailers; and correlate and storing the transaction data and the mobile device data. In some such embodiments, the computer executable code is further to cause the processing device to access the stored transaction data; and, using the accessed transaction data, determine to which of the network customers to present offers. In other such embodiments, the computer executable code is further to cause the processing device to access the stored mobile device data; and, using the accessed mobile device data, determine which of the network customers are proximate the retailer physical location.

### BRIEF DESCRIPTION OF THE DRAWINGS

Having thus described embodiments of the invention in general terms, reference will now be made to the accompanying drawings, where:

FIG. 1 is a block diagram of environment 100, in which systems operate according to embodiments of the invention; and

FIG. 2 is a flowchart illustrating a method 200 for providing offers and/or messages to one or more customers associated with a federated network of retailers.

### DETAILED DESCRIPTION OF EMBODIMENTS OF THE INVENTION

Embodiments of the present invention now may be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure may satisfy applicable legal requirements. Like numbers refer to like elements throughout.

Embodiments of the invention are directed to systems, methods and computer program products for communicating messages to one or more customers associated with a federated network of retailers. Embodiments determine that one or more customers associated with the federated network of retailers are in proximity to a retailer physical location associated with a retailer that is a member of the federated network of retailers; and present an offer to one or more of the federated network customers in proximity to the retailer. In some embodiments, determining comprises recognizing a mobile device is associated with a customer of at least one retailer that is a member of the federated network of retailers. Some embodiments determine that a customer in proximity to the retailer physical location is not a customer of the retailer associated with the physical location and is a customer associated with the federated network of retailers; and present the offer is based on determination. In some embodiments, the offer is associated with the physical location or the retailer associated with the physical location.

In some embodiments, the computer executable code is further to cause the processing device to collect transaction data and mobile device data, each associated with customers of a plurality of retailers that are members of the federated network of retailers; and correlate and storing the transaction data and the mobile device data. Some such embodiments access the stored transaction data; and, using the accessed transaction data, determine to which of the network customers to present offers. Some such embodiments access the stored mobile device data; and, using the accessed mobile device data, determine which of the network customers are proximate the retailer physical location.

The present invention has several applications. A network of retailers is managed by an entity that may or may not be created for that purpose. This network of retailers may be termed a federated network of retailers, and the entity managing the network, also referred to herein as a “third party” typically has access to data regarding each of the retailer network members. The network may bring together retailers in other ways as well, such as providing for accepting of mobile payments for each of the network participant retailers. As an example of the configuration of the network, the third party manager of the network may have access to data regarding transactions that the member retailers conduct with their customers. This data may include data regarding the types of transactions, locations of transactions and the like, and may be correlated to a customer, such as by correlating the transaction data with mobile device data that may indicate the identity of the mobile device of the customer. Mobile device data may be or include a number or other alias identifying the user's mobile device as a unique mobile device. In some instances, customers opt-in to participation in the program and the federated network of retailers by registering. This may include creating a network account, registering the user's mobile device (which in some instances includes registering information tending to identify the mobile device and/or the customer), and/or submitting preference information such as whether the customer would like offers and/or other messages to be communicated to the customer, such as through the customer's mobile device.

In various embodiments, the third party manager has access to data regarding some or all the network of retailers, whereas each individual retailer may only have access to data regarding transactions and/or customers of that particular retailer. Thus, there is an advantage to the third party manager providing messaging and/or offer services to the member retailers so that the retailers may have access to customers who may otherwise be outside their network of customers.

In some instances, the third party manager of the network aggregates transaction data from the member retailers and/or aggregates mobile device data that may be correlated to the transaction data. This data may then be stored, analyzed and retrieved as necessary in order to identify customers that are registered with the network and that demonstrate certain transactional behaviors that correspond to behaviors for which one or more member retailers may wish to send offers and/or messages.

The offers and/or messages may be provided to various segments of customers or groups of customers within a specific merchant's location as determined through geo-location of the customers' mobile devices (as discussed herein with reference to step 240). Each customer's mobile device may be registered and thereby recognized, or the mobile device may communicate directly with a retailer system and/or a third party server or otherwise in order to communicate mobile device information identifying the mobile device. In some embodiments, the third party has access to data (“third party data”) that may be used to determine which users at a specific merchant location to which the merchant should push offers. The third party data may include data such as detailed “level 3” data associated with transactions that have been performed by customers associated with the federated network of retailers. Data such as the “level 3” data may be used by the member retailers, or in the case where the third party retains exclusive access to such data, by the third party, in order to determine the customer segment that is appropriate for certain offers and/or messages. Such offers and/or messages may be based on the third party data corresponding to each individual customer or may be based on third party data corresponding to a group into which an individual customer fits. The third party data may include data regarding a customer's purchase history at other participating merchants. For example, the third party data may be used to determine which users located at a specific merchant location should be sent messages/offers based on the users' purchase history at other participating merchants, such as competitors, complimentary and/or supplementary merchants. A participating retailer may also provide offers to customers in the network, such as those located at locations of other retailers or who have recently performed transactions at other retailers and/or that are in close proximity to the physical location of the retailer.

In some embodiments, the invention uses the federated network of retailers to aggregate data regarding customer transactions and to provide offers and/or messages to various segments of customers potentially outside a specific merchant's network. The invention may provide messages to customers of the network that are associated with specific identified categories of merchants. For example, the invention may determine categories of merchants that are related to the determined location of the user's mobile device and provide offers for those categories of merchants.

In some embodiments, the invention users the federated network of retailers in order to aggregate data regarding customer transactions and to provide offers and/or messages to various segments of customers potentially outside a specific merchant's network. The invention may provide messages to customers of the network that are associated with specific identified categories of merchants. For example, a merchant may be a grocery store and be interested in providing offers to customers of other grocery stores that are members of the network. Similarly, as another example, a merchant may wish to provide messages to customers of categories of merchants that are complementary or supplementary to the goods and/or services the merchant provides. For example, if a merchant provides music lessons, it may wish to provide messages and/or offers to customers of music instrument stores. The third party may facilitate such offers and/or messages without revealing identity and/or transaction data to the merchant presenting the offers/messages.

In some embodiments, the invention may determine a merchant that is related to the determined location of the user's mobile device and provide offers to all the locations of that specific merchant.

In various embodiments, the invention provides offers to one or more customers associated with the federated network of retailers. This may include determining that one or more customers associated with the network are in proximity to a physical location of a participating retailer. Based on this determination, the retailer and/or the third party may initiate creation, presentation and/or communication of one or more offers and/or messages to the customers in proximity.

In various embodiments, the participating merchants are provided an opportunity to select preferences regarding how much of the aggregated data, such as transaction, mobile device and/or customer data to make available to the third party, certain other participating merchants (such as participating competitors), all other participating merchants or the like. The merchants may also have access to an interface that allows the merchants to select or input messages and/or offers in real time and may present to the merchant information regarding data from the network to which they have access. For example, even if specific transaction and/or mobile device data is not accessible to a merchant because of the rules established by the third party manager and/or because of preferences established by other participating merchants, some other information such as the number of network customers currently shopping in the merchant's location may be presented to the merchant for consideration. Other information that may be provided to the merchant may be the number of potential customers to which offers and/or messages may be communicated based on a variety of criteria selectable by the merchant. In this way, the merchant may make a real time (or historical) decision on the types of messages and/or offers to communicate.

Referring now to FIG. 1, a block diagram of environment 100, in which systems operate according to embodiments of the present invention is shown. FIG. 1 illustrates an environment 100 in which the third party server 120, the user system 110 and the retailer system 150 interact over a network 102. The term “retailer” as used herein may be or include one or more retailers, merchants, businesses, entities, individuals and/or the like. Each of the systems 120 and 150 may communicate over the network 102 with the user system 110. In some embodiments, one or more of the systems 110, 120, and/or 150 communicate directly with one another.

In the various embodiments, the user system 110 is a computer system, mobile device or other computing device used by a client 104 or other user to interact with an organization's servers and/or online content and the like, such as by communicating with the third party server 120 and/or the retailer system 150. The user system 110 includes, in the embodiment shown, a processing device 112 communicatively coupled with a communication device 114 and a file system 116. The processing device, in some embodiments, is configured for controlling operation of the communication device 114 in order to communicate across the network 102, such as, for example, with the third party server 120 and/or the retailer system 150. The file system 116 is or includes a memory device or other memory configured for storing computer readable instructions 118 such as an operating system, applications, such as a browser and others, other computer program code and the like. In some embodiments, the computer readable instructions include an federated network program 119 or application configured for instructing the processing device 112 to providing offers and/or messages to one or more customers associated with a federated network of retailers and/or perform one or more of the methods and/or steps discussed herein. The federated network program 119, in some embodiments, is configured for instructing the processing device 112 to communicate with the third party server, 120 and/or the retailer system 150 either directly or over one or more external networks. The processing device 112, of course, is configured for accessing and/or retrieving some or all the computer readable instructions 118 and executing some or all of them.

In one embodiment, for example, the network 102 is an intranet or other local area network (LAN) and the user system 110, the third party system 120, and the retailer system 150 are all part configured for communicating with one another across the intranet. In such an embodiment, the user system 110, when directed by the user 104 to access a particular intranet webpage, uses a browser program to navigate to the intranet webpage. The browser then requests online interaction, such as webpage content, from the third party server 120 and/or the retailer system 150.

The third party server 120, in some embodiments, is a server such as an organization server. The organization may be a financial institution, entity organized to manage a federated network of retailers or otherwise, in various embodiments. In other embodiments, the third party server 120 represents another type of system. In some such cases, the third party server 120 is considered part of one or more backend systems of a bank. The third party server 120 includes, in some embodiments, a processing device 122 communicatively coupled with a communication device 126 and a file system 124, such as a memory device or memory. The processing device 122 is configured for controlling operation of the communication device 126 for communicating over the network 102 such as with the user system 110 and/or the retailer system 150. The file system 124 is configured for storing computer readable instructions 128, such as, for example, the federated network program 129, an operating system, other applications, other computer executable program code and the like. The federated network program 129 includes program code and/or instructions for performing one or more of the methods and/or method steps discussed herein. The processing device 122, of course, is configured to access and/or retrieve some or all the computer readable instructions 128 and execute some or all of them.

The retailer system 150 is, in some embodiments, a server such as an organization server, a computer system, another computing device or the like. In some embodiments, the retailer system 150 includes a processing device 152 communicatively coupled with a communication device 154 and a file system 156. The processing device 152 is typically configured to control the communication device for communicating across the network 102 with one or more of the other systems, such as the third party server 120 and/or the user system 110. The file system 156 is configured for storing computer readable instructions such as a federated network program 159, an operating system, other computer executable program code, applications and the like. The processing device 152 is configured for accessing and/or retrieving some or all the computer readable instructions 158 from the file system 156 and executing some or all of them. In some embodiments, for example, the federated network program 159 includes program code configured to instruct the processing device 152 to communicate with the user device 110 and/or the third party server 120 either directly or over one or more external networks.

Further, the embodiments described herein may refer to use of a transaction, transaction event, interaction or interaction event. Unless specifically limited by the context, a “transaction” or “interaction” refers to any communication between the user and a merchant, financial institution, insurance company, or other entity, and the terms “transaction” and “interaction” are used interchangeably herein. A “transaction” or “interaction” may also include a bill, statement, purchase at a POT, online purchase, purchase at a merchant, and/or the like. For example, in some embodiments, a transaction may include one or more of the following: purchasing, renting, leasing, bartering, selling, and/or leasing goods and/or services (e.g., groceries, stamps, tickets, DVDs, vending machine items, or the like); withdrawing cash; making payments to creditors (e.g., paying monthly bills; paying federal, state, and/or local taxes and/or bills; or the like); sending remittances; transferring balances from one account to another account; loading money onto stored value cards (SVCs) and/or prepaid cards; donating to charities; and/or the like. For example, a transaction may occur when a user purchases a product at a merchant. In yet other embodiments, for example, a transaction may occur when an entity associated with the user is alerted. A transaction may occur when a user accesses a building, uses a rewards card, and/or performs an account balance query. A transaction may occur as a user's device establishes a wireless connection, such as a Wi-Fi connection, with a point-of-transaction terminal.

In still further embodiments, a transaction may refer to an event and/or action or group of actions facilitated or performed by a user's device, such as a user's mobile system, a merchant system, and/or a combination thereof. A device capable of facilitating or performing a transaction may be referred to herein as a “POT system” or “POT device.” A “point-of-transaction” or “POT” could refer to any location, virtual location or otherwise proximate occurrence of a transaction. A POT system may refer to any device used to perform a transaction, either from the user's perspective, the merchant's perspective or both. In some embodiments, the POT system refers only to a user's system, in other embodiments it refers only to a merchant system, and in yet other embodiments, it refers to both a user device and a merchant device interacting to perform a transaction. For example, in one embodiment, the POT system refers to the user's mobile device configured to communicate with a merchant's system, whereas in other embodiments, the POT system refers to a merchant's system configured to communicate with a user's mobile device, and in yet other embodiments, the POT system refers to both the user's mobile device and the merchant's system configured to communicate with each other to carry out a transaction.

In some embodiments, a POT system is or includes an interactive computer terminal that is configured to initiate, perform, complete, and/or facilitate one or more transactions. A POT system could be or include any device that a user may use to perform a transaction with an entity, such as, but not limited to, an ATM, a loyalty device such as a rewards card, loyalty card or other loyalty device, a magnetic-based payment device (e.g., a credit card, debit card, or the like), a personal identification number (PIN) payment device, a contactless payment device (e.g., a key fob), a radio frequency identification device (RFID) and the like, a computer, (e.g., a personal computer, tablet computer, desktop computer, server, laptop, or the like), a mobile device (e.g., a smartphone, cellular phone, personal digital assistant (PDA) device, MP3 device, personal GPS device, or the like), a merchant terminal, a self-service machine (e.g., vending machine, self-checkout machine, or the like), a public and/or business kiosk (e.g., an Internet kiosk, ticketing kiosk, bill pay kiosk, or the like), a gaming device, and/or various combinations of the foregoing.

In some embodiments, a POT system is operated in a public place (e.g., on a street corner, at the doorstep of a private residence, in an open market, at a public rest stop, or the like). In other embodiments, the POT system, is additionally or alternatively operated in a place of business (e.g., in a retail store, post office, banking center, grocery store, factory floor, or the like). In accordance with some embodiments, the POT system is not owned by the user of the POT system. Rather, in some embodiments, the POT system is owned by a mobile business operator or a POT operator (e.g., merchant, vendor, salesperson, or the like). In yet other embodiments, the POT system is owned by the financial institution offering the POT system providing functionality in accordance with embodiments of the invention described herein.

Referring now to FIG. 2, a flowchart illustrates a method 200 for providing offers and/or messages to one or more customers associated with a federated network of retailers according to embodiments of the invention. The first step, represented by block 210, is to collect transaction data associated with customers of a plurality of retailers that are members of a federated network of retailers. The next step, represented by block 220, is to collect mobile device data associated with customers of a plurality of retailers that are members of the federated network of retailers. The next step, represented by block 230, is to correlate and store the transaction data and the mobile device data. For example, the data may be correlated by the third party server 120 and stored in a database for subsequent retrieval and use.

The next step, represented by block 240, is to determine that one or more customers associated with the federated network of retailers are in proximity to a retailer physical location associated with a retailer that is a member of the federated network of retailers.

The location of the user may be determined based on the location of the user's mobile device. Embodiments of the invention may collect positioning data of the customer, which may include global positioning data. Global positioning data may include any information collected from methods, systems, apparatus, computer programs etc. involving locating a user's position relative to satellites, fixed locations, beacons, transmitters or the like. In some instances, global positioning data may be collected from a GPS device, such as a navigation system. Such a navigation system may be, but is not limited to, hardware and/or software that is part of a mobile phone, smartphone, PDA, automobile, watch etc. or a commercially available personal navigation system. The amount, nature and type of the global positioning data that is collected may depend on the merchant's relationship with the customer and the amount of information that the customer has authorized the merchant or third-party provider to collect. For instances in some embodiments the global positioning data will be snapshots of the user's location at different times. For example, a snapshot of the user's location may be collected each time the GPS software, navigation system or application is activated. The global positioning data may also include the destination entered by the user, recent searches for locations, attractions, addresses etc. In other instances, the global positioning data may be the complete route being provided to the GPS system's user, including destination, route, alternate routes, anticipated time of arrival etc. In some such embodiments, the global positioning data may include an indication if the customer selects a detour from a previously selected route, or instructs the navigation system to reach the desired location taking specific roads or avoiding certain roads. In instances where the user's complete route is provided, additional positioning data may not be necessary to project the route of the customer or can be used to confirm the customer is traveling on along the suggested route.

Positioning data of the customer may include mobile device data. Mobile device data may include information regarding the location of the customer's mobile device. Such a mobile device may include, but is not limited to, a cellular telecommunications device (i.e., a cell phone or mobile phone), personal digital assistant (PDA), smartphone, a mobile Internet accessing device, or other mobile device including, but not limited to portable digital assistants (PDAs), pagers, gaming devices, laptop computers, tablet computers, and any combination of the aforementioned, or the like. For instance, the location of the mobile phone may be dynamically determined from the cell phone signal and cell towers being accessed by the mobile phone. In other instances, a mobile device may include software or hardware to locate the position of the mobile phone from GPS signals, wireless network locations, and the like. Mobile device data may further include information from an accelerometer that is a part of the mobile device and provides information regarding whether the mobile device is moving, and if so, in what direction. In some embodiments, mobile device data may be the time and location of calls placed using the telephone functionality of a mobile device. In yet other embodiments, the mobile device data may be data collected and analyzed by the hardware and/or software of the mobile device concerning the surrounding environment. In such embodiments, hardware, such as a video capture device, camera or the like and software that is stored in the memory of a mobile device captures a video stream of the environment surrounding the mobile device and through object recognition, compass direction, the location of the mobile device, and other such data identifies information about the objects identified in the surrounding environment and/or the environment itself. For example, in use, a user may use the camera built into her smartphone to collect a real-time video stream that includes images of the façade of a store front and the surrounding area. This image may include the store's name from a marquee, a street address (collected from an image of the numbers on the building and of street signs in the video image) and the direction the smartphone is facing (from a compass in the mobile device). Such information may be sufficient to locate the user's position and potentially the direction the user is facing and/or traveling.

The positioning data of the customer may also be collected from social network data. It will also be understood that “social network” as used herein, generally refers to any social structure made up of individuals (or organizations) which are connected by one or more specific types of interdependency, such as kinship, friendship, common interest, financial exchange, working relationship, dislike, relationships, beliefs, knowledge, prestige, geographic proximity etc. The social network may be a web-based social structure or a non-web-based social structure. In some embodiments, the social network may be inferred from financial transaction behavior, mobile device behaviors, etc. The social network may be a network unique to the invention or may incorporate already-existing social networks as well as any one or more existing web logs or “blogs,” forums and other social spaces. Social network data may indicate the customer's recent, present or future location through expressed data. For instance, a user may upload a blog post, comment on a connection's page, send a friend an electronic message etc. that she is traveling to a specific location or that she is currently in a specific city, or on a specific road etc. Moreover, many already-existing social networks provide users with the ability to “check-in”, “flag” or otherwise indicate the user's current location. Accordingly, customer positioning data collected from social networking data may consist of such indications. Furthermore, many social networks allow users to rate, like, comment etc. on restaurants, attractions, locations and the like. Accordingly, a customer may indicate that she ate at a certain restaurant or business at a given time and thereby provide information about her location at that time. Furthermore, a customer may upload photographs to a social networking site and thereby provide information about the customer's location. In some instances the customer's location may be determined from the picture, (for example a picture of a state line sign, a highway sign, a mile marker etc.) or a caption associated with the picture may indicate the customer's location and/or the time the photo was taken.

The positioning data of the customer may also be collected from Internet data. Internet data, may include any information relating to the searches conducted by the customer, website's visited by the customer and the like that suggests the customer's present or future location(s). For instance, in preparing for a vacation a customer may conduct searches for hotels, restaurants or activities in the area where the customer will be staying. Similarly, a customer may review weather forecasts for locations other than her place of residence indicating that she may soon be traveling to that location. A customer may also search for construction or traffic reports indicating future travel along certain roads. Moreover, changes in search patterns may suggest a customer's future location. For instance if a customer usually uses a web browser application just to read online news articles or to check sports scores but suddenly begins to search for camping gear, hiking manuals and boots it may be indicative that the customer is anticipating taking a hiking trip and will be traveling away from her home area. It will be understood that such Internet data may relate to searches or websites visited by the customer before she began traveling, however, inasmuch as many mobile devices also include mobile Internet connectivity, it will also be understood that such information may be dynamically collected as the customer travels.

Once the positioning data of the customer is collected from one or more of the global positioning data, mobile device data, social network data and Internet data, the positioning data is analyzed to project the customer's likely route of travel. It will be understood that the positioning data may be data that is available directly to the merchant or data that is collected by other merchants or a third-party service provider and then provided to the merchant. For example, in use, a customer in City One may engage in a transaction consisting of using a credit card to pay a cab fare. The customer's GPS device on her mobile phone, or a phone call placed around the same time, may indicate that she is still in City One but a review of her social networking data indicates she has checked-in on her social network page at City Two Airport. Internet data from the customer's mobile phone indicates that she has recently checked the weather a number of times in City Three. Based on this information, the financial institution may conclude that the customer is likely traveling by plane from City One to City Two.

In some instances in projecting the customer's likely route of travel, the projection will be based on the information currently being collected, e.g. the user's current GPS location, the most recent social network and Internet search data etc. In other instances, the current data will be combined with historical positioning data to project the customer's likely route of travel. For instance, if historical positioning data indicates that when the user leaves her home traveling south bound and then turns onto a specific highway, ninety percent of the time she is traveling to the beach, this information might be used in the future to project the customer's likely route of travel when she begins to follow a similar route. Similarly, the positioning data being currently collected about the customer may be combined with information regarding the travel patterns of other users in similar situations to project the customer's likely route of travel.

The next step, represented by block 250, is to present one or more offers and/or initiate communication of one or more messages to one or more of the customers in proximity to the retailer. The offers and/or messages may be initiated by a retailer that is a member of the federated network of retailers and/or by the third party entity that manages the third party server and the federated network of retailers.

In some embodiments, an “entity” may be a financial institution or some other entity designed and/or organized for the purpose of managing a federated network of retailers. For the purposes of this invention, a “financial institution” may be defined as any organization, entity, or the like in the business of moving, investing, or lending money, dealing in financial instruments, or providing financial services. This may include commercial banks, thrifts, federal and state savings banks, savings and loan associations, credit unions, investment companies, insurance companies and the like. In some embodiments, the entity may allow a user to establish an account with the entity. An “account” may be the relationship that the user has with the entity. Examples of accounts include a deposit account, such as a transactional account (e.g., a banking account), a savings account, an investment account, a money market account, a time deposit, a demand deposit, a pre-paid account, a credit account, a non-monetary user profile that includes only personal information associated with the user, or the like. The account is associated with and/or maintained by the entity. In other embodiments, an entity may not be a financial institution. In some embodiments, the “user” may be a customer (e.g., an account holder or a person who has an account (e.g., banking account, credit account, or the like) at the entity).

An entity (e.g., a financial institution) may send an offer to a user (e.g., an account holder). The offer may be presented the user via at least one of the user's federated network customer account, electronic banking account (e.g., online banking account, mobile banking account on a portable mobile communication device, or the like), the user's social network account, email, or text message. In some embodiments, the user may select an option associated with the presented offer to accept the offer. When the user accepts the offer, the offer is activated so that if the user uses an eligible payment method (as determined by the entity or the merchant) to make a purchase associated with the offer, the user receives the benefit associated with the offer. In other embodiments, the offer may be automatically activated if the user has previously chosen to automatically activate offers associated with particular types (e.g., associated with particular merchants or product or service types). In some embodiments, the entity or the merchant may determine that a user may choose among multiple eligible payment methods in order to make a purchase associated with the offer.

As an example, the activated offer may be a rebate of $5 on a purchase of $20 from a department store. The user may decide to use the offer by visiting the department store and making a purchase of $20. In some embodiments, at the point of sale, the user pays $20 for the user's purchase using an eligible payment method determined by the financial institution or the merchant (e.g., payment card, mobile device payment, check, or the like). When the transaction is processed by the financial institution at a predetermined settlement time in the future (e.g., as part of a periodic batch processing operation to generate monthly account statements), the financial institution provides a rebate of $5 to the user's financial institution account. Therefore, the department store, at the point of sale, may have no knowledge that the user will receive a rebate at some point in the future. In some embodiments, even the user may not be aware of the rebate at the point of sale (e.g., if the offer was automatically activated). In other embodiments, the point of sale terminal may provide an indication to at least one of the department store or the user that the user will receive a rebate at some point in the future.

In various embodiments, one or more of the method steps discussed above may be combined with one or more of the method steps discussed with reference to the same and/or different figures. In various embodiments one or more of the method steps discussed above are not required and are omitted from the method. In various embodiments, one or more of the method steps discussed above may be combined with one or more of the other method steps discussed above and/or one or more additional steps not discussed herein.

In accordance with embodiments of the invention, the term “module” with respect to a system may refer to a hardware component of the system, a software component of the system, or a component of the system that includes both hardware and software. As used herein, a module may include one or more modules, where each module may reside in separate pieces of hardware or software.

Although many embodiments of the present invention have just been described above, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. Accordingly, the terms “a” and/or “an” shall mean “one or more,” even though the phrase “one or more” is also used herein. Like numbers refer to like elements throughout.

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, stored procedures in a database, etc.), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, JavaScript, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatus and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g., a memory, etc.) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

What is claimed is:

1. A system for communicating messages to one or more customers associated with a federated network of retailers, the system comprising:
a memory device storing computer executable code;
a processing device to execute the computer executable code to cause the processing device to:
determine that one or more customers associated with the federated network of retailers are in proximity to a retailer physical location associated with a retailer that is a member of the federated network of retailers; and
present an offer to one or more of the federated network customers in proximity to the retailer.

2. The system of claim 1, wherein determining comprises recognizing a mobile device is associated with a customer of at least one retailer that is a member of the federated network of retailers.

3. The system of claim 1, wherein the computer executable code is further to cause the processing device to:
determine that a customer in proximity to the retailer physical location is not a customer of the retailer associated with the physical location and is a customer associated with the federated network of retailers; and
present the offer is based on determination.

4. The system of claim 1, wherein the offer is associated with the physical location or the retailer associated with the physical location.

5. The system of claim 1, wherein the computer executable code is further to cause the processing device to:
collect transaction data and mobile device data, each associated with customers of a plurality of retailers that are members of the federated network of retailers; and
correlate and storing the transaction data and the mobile device data.

6. The system of claim 5, wherein the computer executable code is further to cause the processing device to:
access the stored transaction data; and
using the accessed transaction data, determine to which of the network customers to present offers.

7. The system of claim 5, wherein the computer executable code is further to cause the processing device to:
access the stored mobile device data; and
using the accessed mobile device data, determine which of the network customers are proximate the retailer physical location.

8. A computer program product configured for communicating messages to one or more customers associated with a federated network of retailers, the computer program product comprising a non-transitory computer readable medium having computer executable code stored thereon to cause a processing device to:
determine that one or more customers associated with the federated network of retailers are in proximity to a retailer physical location associated with a retailer that is a member of the federated network of retailers; and
present an offer to one or more of the federated network customers in proximity to the retailer.

9. The computer program product of claim 8, wherein determining comprises recognizing a mobile device is associated with a customer of at least one retailer that is a member of the federated network of retailers.

10. The computer program product of claim 8, wherein the computer executable code is further to cause the processing device to:
determine that a customer in proximity to the retailer physical location is not a customer of the retailer associated with the physical location and is a customer associated with the federated network of retailers; and
present the offer is based on determination.

11. The computer program product of claim 8, wherein the offer is associated with the physical location or the retailer associated with the physical location.

12. The computer program product of claim 8, wherein the computer executable code is further to cause the processing device to:
collect transaction data and mobile device data, each associated with customers of a plurality of retailers that are members of the federated network of retailers; and
correlate and storing the transaction data and the mobile device data.

13. The computer program product of claim 12, wherein the computer executable code is further to cause the processing device to:
access the stored transaction data; and
using the accessed transaction data, determine to which of the network customers to present offers.

14. The computer program product of claim 12, wherein the computer executable code is further to cause the processing device to:
access the stored mobile device data; and
using the accessed mobile device data, determine which of the network customers are proximate the retailer physical location.

15. A computer-implemented method for communicating messages to one or more customers associated with a federated network of retailers, the method comprising:
providing a memory device storing computer executable code and a processing device to execute the computer executable code to cause the processing device to:
determine that one or more customers associated with the federated network of retailers are in proximity to a retailer physical location associated with a retailer that is a member of the federated network of retailers; and
present an offer to one or more of the federated network customers in proximity to the retailer.

16. The method of claim 15, wherein determining comprises recognizing a mobile device is associated with a customer of at least one retailer that is a member of the federated network of retailers.

17. The method of claim 15, wherein the computer executable code is further to cause the processing device to:
determine that a customer in proximity to the retailer physical location is not a customer of the retailer associated with the physical location and is a customer associated with the federated network of retailers; and
present the offer is based on determination.

18. The method of claim 15, wherein the offer is associated with the physical location or the retailer associated with the physical location.

19. The method of claim 15, wherein the computer executable code is further to cause the processing device to:
collect transaction data and mobile device data, each associated with customers of a plurality of retailers that are members of the federated network of retailers; and
correlate and storing the transaction data and the mobile device data.

20. The method of claim 19, wherein the computer executable code is further to cause the processing device to:
access the stored transaction data; and
using the accessed transaction data, determine to which of the network customers to present offers.

21. The method of claim 19, wherein the computer executable code is further to cause the processing device to:
access the stored mobile device data; and
using the accessed mobile device data, determine which of the network customers are proximate the retailer physical location.
